(19) United States
(12) Patent Application Publication
(10) Pub. No.: US 2018/0058570 A1
(43) Pub. Date: Mar. 1, 2018

(54) LUBRICATING SYSTEM FOR A VEHICLE TRANSMISSION COMPONENT, VEHICLE THEREWITH, AND METHOD OF LUBRICATING A TRANSMISSION COMPONENT

(71) Applicant: JAGUAR LAND ROVER LIMITED, Warwickshire (GB)

(72) Inventors: Russell OSBORN, Whitley, Coventry, Warwickshire (GB); Jaimie FOSTER, Whitley, Coventry, Warwickshire (GB)

(21) Appl. No.: 15/558,581

(22) PCT Filed: Mar. 17, 2016
(86) PCT No.: PCT/EP2016/055855

§ 371 Date: Sep. 15, 2017

(30) Foreign Application Priority Data
Mar. 18, 2015 (GB) 1504598.2

(51) Int. Cl. F16H 57/04

(52) U.S. Cl. CPC F16H 57/0409; F16H 57/0405; F16H 57/0436; F16H 57/045; F16H 57/0483; F16H 57/0495; F16H 57/0469

(57) ABSTRACT

The present invention relates to a lubricating system for a vehicle transmission component. The system comprises a lubricating circuit (44) for supplying lubricant to a transmission component, the circuit (44) including a reservoir (46), a supply path for supplying lubricant from the reservoir (46) to the transmission component, and a return path for returning lubricant from the transmission component to the reservoir (46). The system also comprises an electrical pump (52) for pumping lubricant from the reservoir (46) to the transmission component and a controller (56) arranged to monitor a driving condition and configure the electrical pump (52) to pump a predetermined flow rate of lubricant to the transmission component based on the current driving condition.

### TECHNICAL FIELD

The present disclosure relates to a lubricating system and particularly, but not exclusively, to a lubricating system for a transmission component of a vehicle such as a land vehicle. Aspects of the invention relate to a lubricating system for a transmission component of a vehicle, a vehicle, and a method of lubricating a transmission component of a vehicle.

### BACKGROUND

A vehicle, such as a car or the like, includes various rotating components. Typical rotating components include those forming a transmission and driveline system of the vehicle including a gear box and a final drive gear. Such transmission and driveline systems are referred to hereinafter as transmission systems. Such components require lubrication to reduce wear and reduce temperature in-use.

Vehicles typically employ a lubricating system for lubricating the transmission components. Known lubricating systems come in two general configurations; firstly a wet sump configuration or, secondly, a dry sump configuration.

Wet sump lubricating systems include a lubricant sump beneath a main rotating component, such as a ring gear of a final drive unit. The ring gear churns the lubricant in which it is immersed and transfers the lubricant to, for example, a pinion bearing. However, such wet sump configurations are fraught with inefficiencies. One inefficiency relates to churn loss as the ring gear rotates through the lubricant causing drag on the ring gear. In addition, especially at cold temperatures when the lubricant is highly viscous, the lubricant exiting the bearings is slowed down resulting in the bearings becoming flooded, which causes increased shearing forces across the lubricant. An effect known as bearing spin loss occurs in normal use. However, when the bearings become flooded, bearing spin loss increases.

Gear and bearing churning loss accounts for around 72% of the total final drive unit losses.

Attempts have been made to reduce these losses, for example by employing a dry sump configuration having a remote reservoir and a pump to pump lubricant from the reservoir, via a supply path, to the transmission component. In one such known dry sump lubricating system, a mechanical pump is incorporated which can be coupled and decoupled to pump a speed dependent flow rate of lubricant to the transmission component. Such a system aids with reducing gear churn losses but does little to improve bearing spin loss.

It is an object of the present invention to address disadvantages associated with the prior art.

### SUMMARY OF THE INVENTION

Aspects and embodiments of the invention provide a lubricating system for a vehicle transmission component, a vehicle, and a method of lubricating a transmission component as claimed in the appended claims.

According to an aspect of the present invention there is provided a lubricating system for a vehicle transmission component. The system may comprise a lubricating circuit for supplying lubricant to the transmission component. The circuit may include a separate reservoir. The circuit may include a supply line for supplying lubricant from the reservoir to the transmission component. The circuit may include a return path for returning lubricant from the transmission component to the reservoir. The system may comprise an electrical pump for pumping lubricant from the reservoir to the transmission component. The system may comprise a controller arranged to monitor a driving condition of the vehicle, the driving condition comprising a fuel cut signal, and the controller being arranged to configure the electrical pump to pump a predetermined flow rate of lubricant to the transmission component based on the current driving condition.

By ‘separate’ is meant that the reservoir may be separated from the dry sump base by a baffle and thus not remote from the final drive housing (i.e. the reservoir may be formed integrally with the final drive housing).

The electrical pump allows for flow rate to be more controllable than employing a mechanical pump. By “current driving condition” is meant the driving condition at the time of pumping the lubricant. In addition, basing the lubricant flow rate on the current driving condition allows for the flow rate to be optimized accordingly in order to maximize efficiencies, reduce energy losses, and provide sufficient lubrication to protect components.

By ‘fuel cut’ is meant a situation in which a vehicle has momentum, but engine fuel demand request is zero and that the engine is still coupled to the wheels. Note that this is different to a stop/start system, where a vehicle has zero momentum as it is at rest.

The driving condition may comprise one or more of lubricant temperature, speed, torque, and vehicle inclination.

Considering lubricant temperature as the driving condition, at higher temperatures lubricant viscosity decreases which decreases lubricant film thickness and thereby increases friction. Higher friction means more heat generation at the friction surfaces, requiring a higher lubricant flow for greater cooling to avoid localised over-heating.

Considering torque as the driving condition, at higher torque more power loss results which increases heat generation, therefore more lubricant flow is required for greater cooling to avoid localised over-heating.

Considering speed as the driving condition, at low speeds lubricant film thickness decreases and thereby increases friction. Higher friction means more heat generation at the gear and bearing contacts, requiring a higher lubricant flow for greater cooling to avoid localised over-heating. At moderate speeds the converse is true and lubricant flow rate can be reduced. At higher speeds, lubricant is flung off rotating components and a higher flow rate may be required to prevent lubricant starvation. The trajectory of lubricant delivered by the lubricating system will vary with vehicle inclination. The flow rate will therefore need to be adjusted with inclination to ensure optimal supply to the target components. If lubrication demand is at very low rate or zero based on other parameters, then an enhanced rate of lubrication will be provided using an algorithm based on time, revolutions or energy to prevent starvation occurring. This enhanced rate may be supplied intermittently in bursts.

During fuel cut, lubricant warm-up may be required at low temperatures. Once the lubricant has reached or exceeded a desired operating temperature, warm-up operation will no longer be required. This is a motivation for using lubricant temperature as the driving condition in warm-up conditions (particularly during fuel cut). In addition, axle torque will be negative if the vehicle is in an over-run state. This is a motivation for using torque as the driving condition in warm-up operation (particularly during fuel cut). Finally, monitoring axle speed will determine if the axle is at very low speed or stationary, thus any warming effect will be minimal and the lubricant supply can be reduced. This is a motivation for using speed as the driving condition in warm-up operation (particularly during fuel cut).

The driving condition may comprise one or more off-road conditions, which off-road conditions may include grade detection, side slope, longitudinal acceleration, and lateral acceleration.

The lubricating circuit may be a dry-sump configuration. Said dry-sump configuration may improve efficiency by reduction of gear churning losses.

The transmission component may comprise a final drive gear.

The supply line may be arranged to direct lubricant to a pinion bearing, a differential case bearing, or a pinion/ring gear mesh point of the final drive gear. These points are all associated with high energy losses since there is frictional contact between mutually moving parts. In particular, pinion bearings are associated with very high energy losses when not targeted. Targeting the pinion bearings reduces bearing spin loss and dramatically reduces the associated energy losses of the transmission system.

The controller may be arranged to detect the actual flow-rate of lubricant through the supply line and may emit a warning if the actual flow rate falls below an acceptable actual flow rate of lubricant. Such a warning can serve to warn the driver that there are irregularities within the transmission system, or lubricating system such as clogging of a filter. In addition, the warning may serve to restrict vehicle performance so as to prevent lubricant starvation, for instance in the cases of maximum power or maximum speed.

The lubricating system may comprise a contaminant determining means for determining a level of contaminant within the lubricant, and wherein the controller may be arranged to emit a warning when a level of contaminant exceeds an acceptable threshold level. Such a warning can prompt a vehicle owner to change the lubricant.

The or each warning may be directed to a human machine interface within a vehicle cabin. Such an arrangement is more easily visible to a driver of the vehicle meaning that the warning will be detected quicker and likely to be addressed in a more timely fashion.

According to a further aspect of the invention there is provided a vehicle comprising the aforementioned lubricating system.

According to a further aspect of the invention there is provided a method of lubricating a transmission component of a vehicle. The method may comprise monitoring a driving condition of the vehicle (10), the driving condition comprising a fuel cut signal. The method may comprise determining a flow rate of lubricant to be pumped from a lubricant reservoir to a transmission component based on the current driving condition. The method may comprise using a controller, controlling an electrical pump to pump the determined flow rate of lubricant from the reservoir, through a supply line to the transmission component.

The driving condition may comprise one or more of lubricant temperature, vehicle speed, torque, and vehicle inclination.

The driving condition may comprise one or more off-road conditions, which off-road conditions include grade detection, side slope, longitudinal acceleration, and lateral acceleration.

The method may comprise configuring the electrical pump to base the flow rate of lubricant on torque when the lubricant is below a predetermined temperature, or alternatively at any suitable lubricant temperature. For instance, towing a high load from rest would result in high torque, which would require a higher than usual flow rate of lubricant to compensate.

The method may comprise providing increased power to the electrical pump to direct a relatively high flow rate of lubricant to the transmission component when the lubricant is below a predetermined temperature. Cold lubricant is highly viscous. Accordingly, it may be necessary to pump a higher than ordinary pumping power since the high viscosity of lubricant may mean that insufficient lubricant is actually pumped. For instance, a positive displacement pump pumps a constant volume of lubricant. However, when the temperature is cold, viscosity increases which results in the pump rotating less quickly than desired. Accordingly, the target location for lubricating is under lubricated.

The predetermined temperature may be about 40° C. Viscosity of a lubricant is highest within this temperature range.

The driving condition may comprise engine over-run and/or braking and wherein the method may comprise configuring the electrical pump to direct a relatively high flow rate of lubricant to the transmission component when the current driving condition is engine over-run and/or braking. Over-run and engine braking are both associated with the vehicle running faster than desired so increasing the flow rate in these situations will warm up the lubricant at a time when energy losses within the transmission and/or driveline system are not important since the vehicle is decelerating anyway. In addition, in these cases, fuel is not supplied to the engine. Accordingly, energy used to power the electrical pump is not being taken from the engine fuel but likely from recovered energy from braking or a generator.

The relatively high flow rate of lubricant may be the maximum flow rate of lubricant deliverable by the electric pump. Accordingly, a large amount of heat generation can occur in these aforementioned conditions, which heat generation can transfer to the lubricant.

The transmission component may comprise a final drive gear and wherein the method may comprise directing the lubricant through the supply line to a pinion bearing, a differential case bearing, or a pinion/ring gear mesh point of the final drive gear.

The method may comprise detecting or calculating the actual flow rate of lubricant and may comprise emitting a warning when the actual flow rate of lubricant falls below an acceptable actual flow rate of lubricant.

The method may comprise detecting a level of contaminant within the lubricant and may comprise emitting a warning when the level of contaminant exceeds an acceptable threshold level.

The or each warning may be directed to a human machine interface within a vehicle cabin or may be available to be processed by a service diagnostic tool.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, in which:

FIG. 1 shows a schematic diagram of a vehicle showing various transmission components;

FIG. 2 shows a schematic diagram of a lubricating system, according to an embodiment of the present invention, for lubricating a transmission component from FIG. 1; and

FIG. 3 shows a plot of viscosity against temperature for a lubricant used by the lubricating system from FIG. 2.

### DETAILED DESCRIPTION

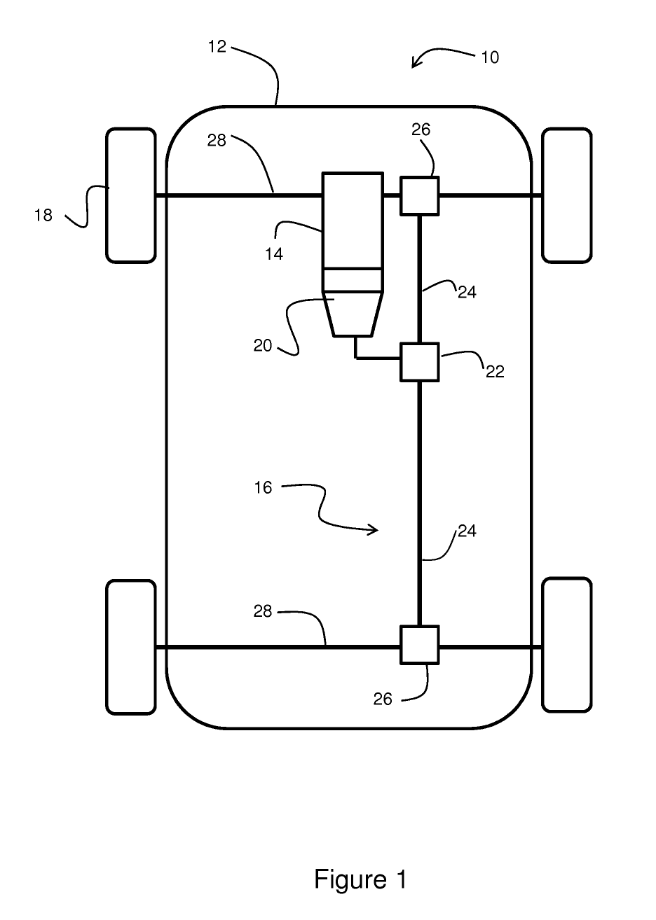

With reference to FIG. 1, a vehicle 10, such as a car or other land vehicle, includes a chassis 12 supporting an engine 14 and a transmission and/or a driveline system 16 transmitting power from the engine to the wheels 18. Reference to the transmission and/or driveline system is hereinafter described as the transmission system. In this instance there are four wheels 18, all of which are driven wheels since this this vehicle 10 is embodied as a four wheel drive vehicle.

The transmission system 16 includes various transmission components including a gear box 20, a transfer drive unit 22, fore and aft drive shafts 24, fore and aft final drive units 26, or colloquially, differentials, and front and rear side shafts 28. The fore and aft ends of the drive shaft 24 are connected to front and rear final drive units 26. The differentials 26 are connected to front and rear side shafts 28 which in turn are connected to near side and off side wheels 18. The differentials 26 are used to distribute power between the near-side and off-side wheels 18 during a turn, or in some cases where traction is limited on an individual wheel relative to the other. It will be appreciated that where the term differential is colloquially used, the final drive unit may not contain differential gearing but may comprise clutches to apportion torque during cornering. In such a final drive unit, the bearings supporting the final drive gear are herein referred to as differential case bearings for simplicity of description.

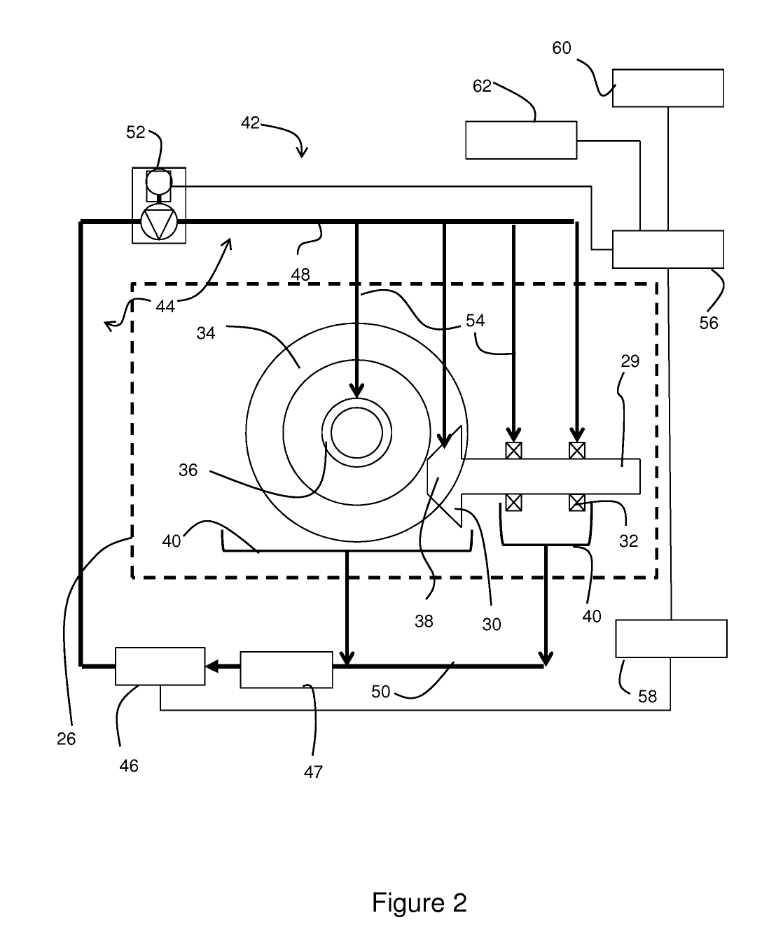

With reference to FIG. 2, the final drive unit 26 includes a pinion shaft 29 driven by the prop shaft (not shown). A pinion 30 is mounted to the end of the pinion shaft 29. Pinion bearings 32 are provided to journal the pinion shaft 29 within a final drive housing (not shown) during rotation of the shaft 29. The final drive unit 26 also includes a ring gear 34 which is journalled about differential case bearings 36 during rotation. Both the pinion 30 and the ring gear 34 have complimentary teeth which mesh together at a mesh point 38. The final drive unit 26 is contained within a housing (not shown) which includes a dry sump base 40. The term dry sump is used since any lubricant used to lubricate the mechanical interfaces of the final drive unit is not maintained in contact with the gears and bearings and is commonly stored in a separate tank.

With continued reference to FIG. 2, the vehicle also includes a lubricating system 42. The lubricating system 42 includes a lubricating circuit 44 for supplying lubricant to the final drive unit 26. The lubricating circuit 44 includes a separate reservoir 46 for collecting lubricant and a supply line 48 for supplying lubricant from the reservoir 46 to the final drive unit 26. The reservoir 46 is remote from the final drive housing. A return line 50 also forms part of the circuit, which return line 50 returns lubricant from the dry sump base 40 to the reservoir 46. However, in practice, the reservoir may be separated from the dry sump base 40 by a baffle and thus not remote from the final drive housing.

The lubricating system 42 also includes an electrical pump 52 for pumping lubricant from the reservoir 46 to the final drive unit 26 via the supply line 48. The supply line 48 has several branches 54. Each branch 54 directs lubricant to a designated location of the final drive unit 26. Those locations include the pinion bearings 32, the mesh point 38 of the pinion 30 and ring gear 34, and the differential case bearings 36. These locations are associated with the highest energy losses of the final drive unit 26, in a dry-sump configuration, and so directing lubricant to these locations is the most efficient way in which to reduce energy losses.

The lubricating system also includes a controller 56. The controller 56 is connected to the electrical pump 52, a sensor 58, a central vehicle data bus 60, and a human machine interface 62 located within a cabin (not shown) of the vehicle.

The sensor is a temperature sensor, a lubricant contaminant sensor, or a flow rate sensor, all being located within the reservoir 46. Alternatively, these may be located elsewhere. The temperature sensor is a thermistor. The lubricant contaminant sensor is a wear debris sensor and includes a strong interior magnet which attracts ferrous particles resulting from wear of the final drive unit's metallic components. The debris sensor uses solid state induction techniques to determine the amount of debris at the sensor's surface and thus calculate the quantity of debris contained within the lubricant. The lubricant temperature and the lubricant quality (amount of debris immersed therein) are both driving conditions which can be used by the controller as will be described in more detail below. In addition, the quantity of foreign particulate matter, such as ferrous wear particles, present in the fuel can be determined indirectly by a pressure drop across a filter.

The flow rate sensor is a positive displacement sensor comprising a gear or rotating vane design. Rotation of the gear or vanes is measured electromagnetically and relates to a fixed volume of lubricant transferred from an inlet to an outlet. An actual flow rate value of the lubricant can be attributed to the lubricant flowing through the supply line since the flow rate sensor is located therein. It is also possible to calculate the flow rate based on the pump power consumption, pump speed and lubricant temperature change using an algorithm stored on a computer system of the vehicle.

The vehicle data bus 60 transmits data to the controller 56 relating to various other driving conditions. Those conditions include vehicle speed and vehicle torque as determined by other control units such as an engine control unit (not shown). Other driving conditions transmitted to the controller 56 by the data bus 60 include driving conditions such as vehicle over-run and/or braking. Where the vehicle is an off-road land vehicle, the driving conditions also comprise one or more off-road conditions, which off-road conditions include grade detection, side slope, longitudinal acceleration, and lateral acceleration. Alternative driving conditions may also be used such as transfer box range, coupling torque, and drive-line disconnect status.

The controller 56 is arranged to monitor the driving conditions and configure the electrical pump 52 to pump a predetermined flow rate of lubricant to the various locations of the final drive based on the current driving condition, at the time of pumping. The way in which the controller 56 selects a desired flow rate for the lubricant is best described with reference to the scenarios outlined below.

When the electrical pump 52 pumps lubricant through the supply line 48, the actual flow rate of lubricant is monitored by the controller 56. The controller 56 is arranged to detect the actual flow-rate of lubricant through the supply line 48 and emit a warning if the actual flow rate falls below an acceptable actual flow rate of lubricant. The warning is sent to the human machine interface 62 to be addressed by a driver. The warning may read “change oil filter” or “service due”. As an alternative, the warning may be available for detection by a service diagnostic tool.

The controller is also arranged to emit a warning when a level of contaminant exceeds an acceptable threshold level. Again this warning is directed to the human machine interface 62 to be addressed by a driver of the vehicle. The warning may read “oil change required” or “service due”.

Operation of the lubricating system is best described with reference to the various scenarios of operation. Some such scenarios are now described though several more are envisaged which are not expressly described but which also fall within the scope of the appended claims.

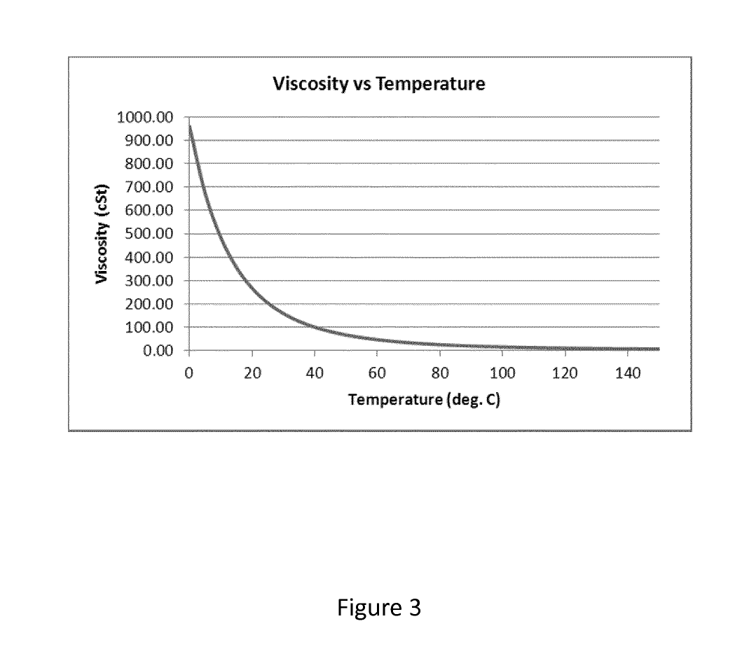

With reference to FIG. 3, one scenario of using the lubricating system involves the controller detecting that the lubricant is cold. Although cold is a generic term, cold is used here to mean when the temperature of the lubricant, or oil, is such that the lubricant is highly viscous. It can be seen in FIG. 3 that there is roughly an inverse square relationship between the viscosity and the temperature of the oil. For temperatures below 20° C., the viscosity is very high and very difficult to act as a lubricant. The same is still true, although less so, for temperatures between 20° C. and 40° C. Accordingly, the controller in this case determines that the lubricant is “too cold” when less than 40° C.

With further reference to FIG. 2, during times of cold lubricant temperature, the controller 56 dictates the flow rate of lubricant to the final drive unit 26 based on vehicle. For fuel cut scenarios, the controller 56 configures the pump to pump relatively high flow rates of lubricant to the final drive unit 26 in an attempt to flood the pinion bearings 32, mesh point 36 and differential case bearings 38. In this way, the lubricant will increase in temperature more rapidly than without this lubricating system 42. To increase heat generation, the electrical pump 52 is set to maximum capacity to transfer the maximum flow rate of lubricant through the supply line to the final drive unit 26.

In addition, if the vehicle speed is high and the lubricant is cold, the controller 56 will configure the electrical pump 52 to pump lower flow rates of lubricant to the final drive unit 26 than that of a wet sump lubrication system so as to reduce drag losses associated with the pinion bearings 32, mesh point 36 and differential case bearings 38 contacting highly viscous lubricant.

As the lubricant temperature increases, to an extent that the lubricant is considered “warm”, e.g. above 40° C., engine torque is used by the controller 56 in addition to engine speed in order to determine the flow rate of lubricant to pump to the final drive unit 26, where efficiency, required lubrication and thermal management become important factors. In addition, the scenario described above, for pumping a higher flow rate of lubricant to the final drive unit 26 at high temperatures, is turned off.

Whilst the lubricant is being pumped to the final drive unit 26, the flow rate is monitored by the controller 56. If the actual flow rate falls below an acceptable flow rate compared to the intended flow rate, the controller 56 emits a warning directed to the human machine interface 62. An acceptable flow rate may be a percentage of the intended flow rate. For instance, within 20% of the intended flow rate may be acceptable in some circumstances, whereas other more critical circumstances may require the actual flow rate to be within 10% of the intended flow rate.

With reference to FIG. 1, in another scenario, the vehicle 10 is in a condition of over-run, where the vehicle is generating less tractive effort than would be required to maintain speed on a level road. In some cases, the engine 14 and transmission system 16 retard the vehicle in what is otherwise known as engine braking. Vehicle over-run can occur in situations such as during a descent down a relatively steep gradient. In addition, or alternatively, the vehicle 10 is retarded by braking using a braking system (not shown) to decelerate the rotational speed of the wheels 18.

With reference to FIG. 2, when the controller 56 detects that either over-run or braking are occurring, the controller 56 configures the electrical pump 52 to operate at a relatively high capacity. In particular, the electrical pump 52 may be set to maximum capacity. In this way, a relatively high, or even maximum, flow rate of lubricant will be transferred from the reservoir, through the supply line to the final drive unit 26. By directing the maximum flow rate of lubricant which may be pumped to the final drive unit 26, the final drive is immersed in a higher than typical volume of lubricant. Maximum heat transfer thus occurs between the final drive unit 26 and the lubricant in such a scenario when the final drive unit is substantially “flooded”. “Flooding” the final drive unit 26 in this way is ordinarily undesirable from an energy loss point of view since such flooding is associated with high drag losses of the final drive unit 26. However, this is not an issue during over-run and/or braking since the vehicle is already retarding. Accordingly, it is advantageous to use times of over-run and/or braking to heat the lubricant. In addition, it is noted that fuel may be cut during over-run or braking. Energy generated by a generator during braking for instance can be used to power the electrical pump 52 instead of using fuel for the engine. In this way, operating the electrical pump 52 during these times is more energy efficient.

There are various other scenarios in which the lubricating system can be used though which are not explicitly described herein but which are within the scope of the appended claims.

1-23. (canceled)

24. A lubricating system for a vehicle transmission component, the system comprising:
a lubricating circuit for supplying lubricant to the transmission component, the circuit including a reservoir, a supply path for supplying lubricant from the reservoir to the transmission component, and a return path for returning lubricant from the transmission component to the reservoir;
an electrical pump for pumping lubricant from the reservoir to the transmission component; and
a controller arranged to monitor a driving condition of the vehicle,
the controller being arranged to configure the electrical pump to pump a predetermined flow rate of lubricant to the transmission component based on a current driving condition,
the controller also being arranged to configure the electrical pump to direct an increased flow rate of lubricant to the transmission component when the current driving condition comprises one of a fuel cut signal, engine over-run, and braking.

25. The lubricating system of claim 24, wherein the driving condition comprises at least one of speed, torque, lubricant temperature, and vehicle inclination.

26. The lubricating system of claim 24, wherein the driving condition comprises at least one off-road condition, including grade, side slope, longitudinal acceleration, and lateral acceleration.

27. The lubricating system of claim 24, wherein the lubricating circuit is a dry-sump configuration.

28. The lubricating system of claim 24, wherein the transmission component comprises a final drive unit.

29. The lubricating system of claim 28, wherein the supply path is arranged to direct lubricant to one or more of a pinion bearing, a differential case bearing, and a pinion /ring gear mesh point of the final drive unit.

30. The lubricating system of claim 24, wherein the controller is arranged to detect an actual flow-rate of lubricant through the supply path and emit a warning if the actual flow rate falls below an acceptable actual flow rate of lubricant, wherein the warning is detectable on at least one of a human machine interface within a vehicle cabin and a service diagnostic tool.

31. The lubricating system of claim 24, comprising a contaminant sensor for measuring contaminant within the lubricant, and wherein the controller is arranged to emit a warning when a level of contaminant exceeds an acceptable threshold level wherein the warning is detectable on at least one of a human machine interface within a vehicle cabin and a service diagnostic tool.

32. A vehicle comprising the lubricating system of claim 24.

33. A method of lubricating a transmission component of a vehicle, the method comprising:
monitoring a driving condition of the vehicle;
determining a flow rate of lubricant to be pumped from a lubricant reservoir to a transmission component based on a current driving condition; and
using a controller for configuring an electrical pump to pump the determined flow rate of lubricant from the reservoir, through a supply path to the transmission component, and
configuring the electrical pump to direct an increased flow rate of lubricant to the transmission component when the current driving condition comprises one of a fuel cut signal, engine over-run, and braking.

34. The method of claim 33, wherein the driving condition comprises at least one of speed, torque, lubricant temperature, and vehicle inclination.

35. The method of claim 33, wherein the driving condition comprises at least one off-road condition, including grade, side slope, longitudinal acceleration, and lateral acceleration.

36. The method of claim 33, comprising configuring the electrical pump to base the flow rate of lubricant on torque when the lubricant is below a predetermined temperature.

37. The method of claim 33, comprising configuring the electrical pump to direct an increased flow rate of lubricant to the transmission component when the lubricant is below a predetermined temperature.

38. The method of claim 36, wherein the predetermined temperature is about 40° C.

39. The method of claim 37, wherein the increased flow rate of lubricant is the maximum flow rate of lubricant which may be pumped by the electric pump.

40. The method of claim 37, wherein the increased flow rate of lubricant is a maximum flow rate of lubricant which may be pumped by the electric pump.

41. The method of claim 33, wherein the transmission component comprises a final drive unit and the method comprises directing the lubricant through the supply path to one or more of a pinion bearing, a differential case bearing, and a pinion/ring gear mesh point of the final drive gear.

42. The method of claim 33, comprising detecting an actual flow rate of lubricant and emitting a warning when the actual flow rate of lubricant falls below an acceptable actual flow rate of lubricant, wherein the warning is detectable on a human machine interface within a vehicle cabin.

43. The method of claim 33, comprising detecting a level of contaminant within the lubricant and emitting a warning when the level of contaminant exceeds an acceptable threshold level, wherein the warning is detectable on a human machine interface within a vehicle cabin.
